(19) United States
(12) Patent Application Publication
(10) Pub. No.: US 2020/0103862 A1
(43) Pub. Date: Apr. 2, 2020

(54) DETERIORATION DETERMINING APPARATUS AND DETERIORATION DETERMINING SYSTEM

(71) Applicant: JTEKT Corporation, Osaka-shi (JP)

(72) Inventors: Yusuke Okubo, Kariya-shi (JP); Masaharu Hasuike, Kariya-shi (JP); Toshiyuki Baba, Kashihara-shi (JP); Kouji Kimura, Shiki-gun (JP)

(73) Assignee: JTEKT Corporation, Osaka-shi (JP)

(21) Appl. No.: 16/580,021

(22) Filed: Sep. 24, 2019

(30) Foreign Application Priority Data
Sep. 27, 2018 (JP) 2018-182675

(51) Int. Cl. G05B 19/418; G06N 20/00; B22C 9/08; B22D 15/00

(52) U.S. Cl. CPC G05B 19/4184; G05B 19/4183; B22D 15/00; B22C 9/082; G06N 20/00

(57) ABSTRACT

A deterioration determining apparatus includes: an operating condition acquirer to acquire an operating condition of a processing device; a processing state data acquirer to acquire processing state data detected by a sensor attached to the processing device; a learning model generator to conduct machine learning using, as learning data, the operating condition and the processing state data so as to preliminarily generate a learning model concerning the operating condition and the processing state data; an actual data acquirer to acquire actual data that is the processing state data at a determining time; a predicted data acquirer to acquire, using the learning model, predicted data that is the processing state data for the operating condition at the determining time; and a determiner to determine the degree of deterioration in the processing device in accordance with the degree of divergence between the actual data and the predicted data.

### INCORPORATION BY REFERENCE

The disclosure of Japanese Patent Application No. 2018-182675 filed on Sep. 27, 2018, including the specification, drawings and abstract, is incorporated herein by reference in its entirety.

### BACKGROUND OF THE INVENTION

### 1. Field of the Invention

The invention relates to deterioration determining apparatuses and deterioration determining systems.

### 2. Description of the Related Art

Japanese Patent Application Publication No. 2017-202632 (JP 2017-202632 A) discloses a method for estimating wear volumes of check valves of injection molding machines. The method involves: performing injection operations, with check valves (which have different wear volumes) attached to the injection molding machines; acquiring physical quantities concerning the injection operations while the injection operations are performed by the injection molding machines; and extracting features of the physical quantities acquired. The method then involves conducting supervised learning using the wear volumes of the check valves as correct information and using the extracted features as inputs. In accordance with the learning results of the supervised learning, the method estimates wear volumes of check valves when random features of physical quantities are input.

### SUMMARY OF THE INVENTION

An object of the invention is to provide a deterioration determining apparatus and a deterioration determining system that determine deterioration in processing devices by an unconventional technique involving the use of machine learning.

A first aspect of the invention provides a deterioration determining apparatus including an operating condition acquirer, a processing state data acquirer, a learning model generator, an actual data acquirer, a predicted data acquirer, and a determiner. The operating condition acquirer acquires an operating condition of a processing device that executes a predetermined process. The processing state data acquirer acquires processing state data detected by a sensor during the execution of the predetermined process by the processing device. The sensor is attached to the processing device. The learning model generator conducts machine learning using, as learning data, the operating condition and the processing state data so as to preliminarily generate a learning model concerning the operating condition and the processing state data. The actual data acquirer acquires actual data. The actual data is the processing state data at a determining time. The predicted data acquirer acquires predicted data using the learning model. The predicted data is the processing state data for the operating condition at the determining time. The determiner determines a degree of deterioration in the processing device in accordance with a degree of divergence between the actual data and the predicted data.

The learning model is preliminarily generated by the learning model generator of the deterioration determining apparatus according to the above aspect. The learning model indicates relationships between the operating condition and the processing state data used for the generation of the learning model. The actual data acquirer acquires the actual data that is the processing state data at the determining time different from a time at which the learning model is generated. The predicted data acquirer acquires the operating condition at the determining time. Using the operating condition acquired and the learning model preliminarily generated, the predicted data acquirer acquires the predicted data that is the processing state data. Because the predicted data is acquired using the preliminarily generated learning model, the predicted data is equivalent to data indicative of a state of the processing device that has operated for the generation of the learning model (i.e., data indicative of a state of the processing device where the degree of deterioration is lower than the degree of deterioration at the determining time). The determiner determines the degree of deterioration in the processing device in accordance with the degree of divergence between the actual data and the predicted data. When the actual data is significantly divergent from the predicted data, the determiner determines that the degree of deterioration in the processing device is significant. When the actual data is slightly divergent from the predicted data, the determiner determines that the degree of deterioration in the processing device is slight.

A second aspect of the invention provides a deterioration determining system including a plurality of processing devices, a server, and the deterioration determining apparatus according to the first aspect. The processing devices each execute a predetermined process. The server is able to communicate with the processing devices. The server collects operating conditions of the processing devices, and processing state data detected by a sensor during the execution of the predetermined process by each of the processing devices. The sensor is attached to each of the processing devices. The deterioration determining apparatus determines a degree of deterioration in each of the processing devices in accordance with the operating conditions and the processing state data collected by the server. Because the server collects a large number of operating conditions and a large number of pieces of processing state data, the deterioration determining system enables the deterioration determining apparatus to determine deterioration with higher accuracy.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a diagram illustrating a configuration of a deterioration determining system;

FIG. 2 is a diagram illustrating a processing device (e.g., an injection molding machine);

FIG. 3 is a block diagram of a first exemplary deterioration determining apparatus;

FIG. 4 is a chart illustrating learning data generated by a learning model generator of the first exemplary deterioration determining apparatus;

FIG. 5 is a graph of exemplary state data during molding, illustrating time-varying behaviors of dwelling pressure data during molding of a single molded article;

FIG. 6 is a flow chart illustrating a first exemplary determining process to be performed by a determiner;

FIG. 7 is a flow chart illustrating a second exemplary determining process to be performed by the determiner;

FIG. 8 is a flow chart illustrating a third exemplary determining process to be performed by the determiner;

FIG. 9 is a flow chart illustrating a fourth exemplary determining process to be performed by the determiner;

FIG. 10 is a block diagram of a second exemplary deterioration determining apparatus; and

FIG. 11 is a chart illustrating learning data generated by a learning model generator of the second exemplary deterioration determining apparatus.

### DETAILED DESCRIPTION OF EMBODIMENTS

A deterioration determining apparatus 100 (or 200) is targeted for a processing device 1 that executes a predetermined process. The deterioration determining apparatus 100 (or 200) determines the degree of deterioration in the processing device 1 (e.g., deterioration in the processing device 1 over time). Examples of the processing device 1 include a molding machine to form a molded article, a processing machine to process a workpiece, and a conveyor to convey an object to be conveyed. Examples of the predetermined process include forming a molded article, processing a workpiece, and conveying an object to be conveyed.

When the entire processing device 1 needs an overhaul (e.g., checkup or maintenance), the deterioration determining apparatus 100 (or 200) may determine deterioration in the entire processing device 1. When component(s) of the processing device 1 need(s) checkup or maintenance, the deterioration determining apparatus 100 (or 200) may determine deterioration in the component(s) of the processing device 1.

The present embodiment will be described on the assumption that the processing device 1, the deterioration of which is to be determined by the determining apparatus 100 (or 200), is a molding machine to supply a molten material into a mold of the molding machine so as to form a molded article. The processing device 1 is, for example, a device to carry out injection molding using resin, rubber or other material or carry out metal casting, such as die casting. The following description is based on the assumption that the processing device 1 is an injection molding machine.

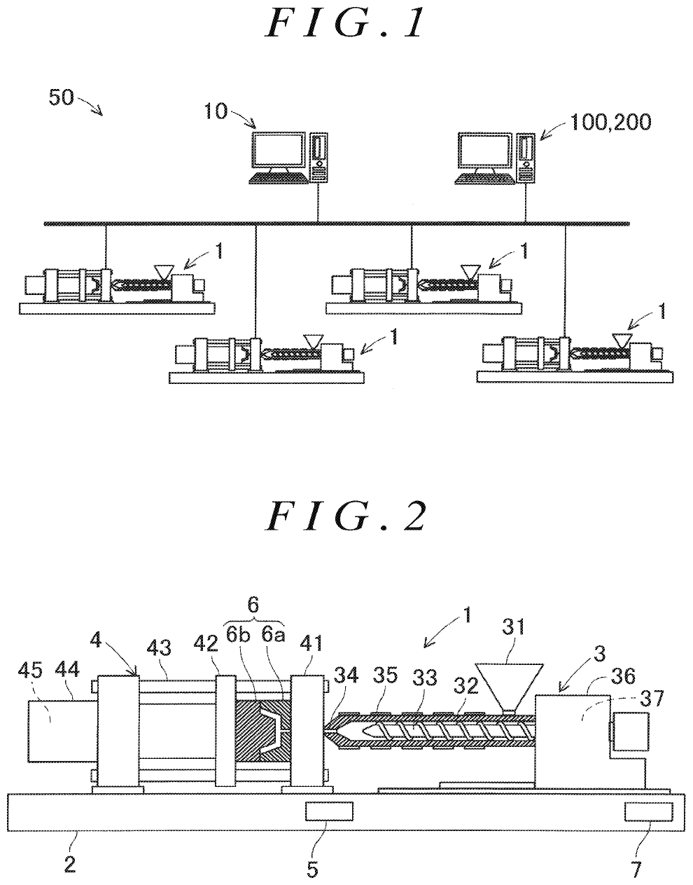

A configuration of a deterioration determining system 50 will be described with reference to FIG. 1. The deterioration determining system 50 includes a plurality of the processing devices 1, a server 10, and the deterioration determining apparatus 100 (or 200). Each of the processing devices 1 executes the predetermined process. Each of the processing devices 1 is, for example, an injection molding machine. The server 10 is able to communicate with the processing devices 1. The server 10 collects operating conditions of the processing devices 1, and processing state data detected by injection unit sensors 37 and mold clamp sensors 45 during execution of the predetermined processes by the processing devices 1. The injection unit sensors 37 and the mold clamp sensors 45 are attached to the processing devices 1. In accordance with the operating conditions and the processing state data collected by the server 10, the deterioration determining apparatus 100 (or 200) determines the degree of deterioration in each of the processing devices 1.

An injection molding machine serving as an example of the processing device 1 will be described with reference to FIG. 2. The processing device 1 (which is an injection molding machine) includes a bed 2, an injection unit 3, a mold clamp 4, a controller 5, and an ambient environment sensor 7. The injection unit 3 is disposed on the bed 2. The injection unit 3 heats and melts a molding material and pours the molten molding material into a cavity of a mold 6 at high pressure. The molding material heated and molten will be referred to as a “molten material”.

The injection unit 3 includes a hopper 31, a heating cylinder 32, a screw 33, a nozzle 34, a heater 35, a driver 36, and the injection unit sensor 37. The hopper 31 includes a feed port through which pellets (e.g., granular molding material) are to be fed into the injection unit 3. The heating cylinder 32 heats the pellets (which have been fed into the injection unit 3 through the feed port of the hopper 31) so as to melt the pellets into a molten material, and pressurizes the molten material. The heating cylinder 32 is axially movable relative to the bed 2. The screw 33 is disposed inside the heating cylinder 32. The screw 33 is rotatable and axially movable.

The nozzle 34 includes an injection port on an end of the heating cylinder 32. Axial movement of the screw 33 causes the nozzle 34 to supply the molten material inside the heating cylinder 32 into the cavity of the mold 6. The heater 35 is provided, for example, on the outer portion of the heating cylinder 32. The heater 35 heats the pellets inside the heating cylinder 32. The driver 36 causes, for example, axial movement of the heating cylinder 32, rotation of the screw 33, and axial movement of the screw 33. The injection unit sensor 37 includes sensor(s) to detect the amount of molten material retained, a dwelling pressure, a dwelling time, an injection speed, a molten material viscosity, and a state of the driver 36. The sensor 37, however, does not necessarily have to detect all of these pieces of information. The sensor 37 may detect any one or more of these pieces of information and/or various other information.

The mold clamp 4 is disposed on the bed 2 such that the mold clamp 4 faces the injection unit 3. The mold clamp 4 opens and closes the mold 6 attached to the mold clamp 4. With the mold 6 clamed, the mold clamp 4 prevents opening of the mold 6 caused by the pressure of the molten material injected into the cavity of the mold 6.

The mold clamp 4 includes a fixed platen 41, a movable platen 42, tie rods 43, a driver 44, and the mold clamp sensor 45. The mold 6 includes a first mold 6a that is fixed, and a second mold 6b that is movable. The first mold 6a is secured to the fixed platen 41. The fixed platen 41 is able to come into abutment with the nozzle 34 of the injection unit 3. The fixed platen 41 guides the molten material, injected from the nozzle 34, into the cavity of the mold 6. The second mold 6b is secured to the movable platen 42. The movable platen 42 is able to move toward and away from the fixed platen 41. The tie rods 43 support the movable platen 42 such that the movable platen 42 is movable. The driver 44 includes, for example, a cylinder device. The driver 44 moves the movable platen 42. The mold clamp sensor 45 includes sensor(s) to detect a mold clamping force, a mold temperature, and a state of the driver 44.

The controller 5 controls the driver 36 of the injection unit 3 and the driver 44 of the mold clamp 4 in accordance with command values concerning molding conditions. Specifically, the controller 5 acquires various pieces of information from the injection unit sensor 37 and the mold clamp sensors 45 so as to control the driver 36 of the injection unit 3 and the driver 44 of the mold clamp 4, such that the driver 36 and the driver 44 operate in response to the command values.

The ambient environment sensor 7 is provided, for example, on the bed 2 of the processing device 1. The ambient environment sensor 7 acquires ambient environment data during execution of the predetermined process by the processing device 1. Examples of the ambient environment data include a time indicator, an ambient temperature, and an ambient humidity. The time indicator indicates, for example, a month in which the predetermined process is executed, a day on which the predetermined process is executed, or a season associated with the month and/or day. Suppose that the time indicator indicates a season. In this case, associations between seasons and months and days are set in advance, so that the ambient environment sensor 7 acquires the time indicator based on the associations.

The following description discusses an injection molding method to be performed by the processing device 1 (which is an injection molding machine). The injection molding method involves sequentially performing a measuring step, a mold clamping step, an injection-filling step, a dwelling and cooling step, and a mold release and removal step. The measuring step involves melting pellets into a molten material by heat applied from the heater 35 and shear frictional heat resulting from rotation of the screw 33. In the course of the measuring step, the molten material is retained between an end of the heating cylinder 32 and the nozzle 34. An increase in the amount of the retained molten material moves the screw 33 backward. The measuring step thus involves measuring the amount of the retained molten material in accordance with how far the screw 33 is moved backward.

The mold clamping step first involves moving the movable platen 42 so as to put the first mold 6a and the second mold 6b together, thus carrying out mold clamping. The mold clamping step then involves connecting the nozzle 34 to the fixed platen 41 of the mold clamp 4. The injection-filling step involves moving the screw 33 toward the nozzle 34, with the rotation of the screw 33 stopped. The injection-filling step thus involves injection-filling the molten material into the cavity of the mold 6 under high pressure. After the injection-filling step, the dwelling and cooling step involves dwelling while the nozzle 34 is kept pressed against the fixed platen 41, such that the molten material in the cavity of the mold 6 is maintained at a predetermined pressure. The dwelling and cooling step then involves cooling the mold 6 so as to solidify the molten material in the cavity of the mold 6. Finally, the mold release and removal step involves bringing the first mold 6a and the second mold 6b away from each other so as to remove a molded article from the mold 6.

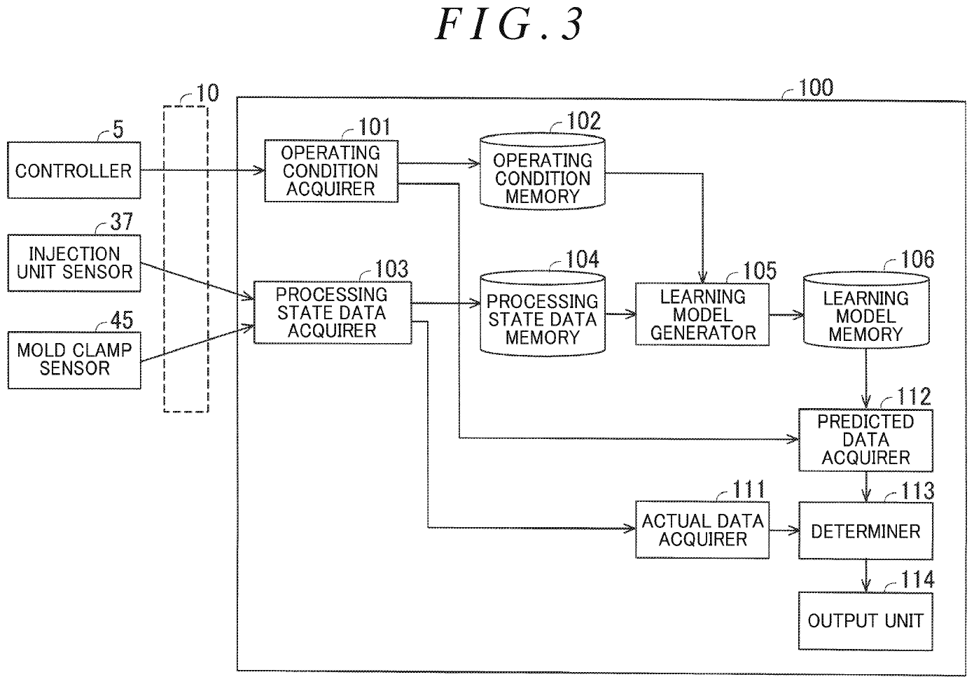

The deterioration determining apparatus 100 according to a first example (which may hereinafter be referred to as a “first exemplary deterioration determining apparatus 100”) will be described with reference to FIGS. 3 to 5. The deterioration determining apparatus 100 includes components that function in a learning phase of machine learning, and components that function in an estimating phase of machine learning.

As illustrated in FIG. 3, the components of the deterioration determining apparatus 100 that function in the learning phase include an operating condition acquirer 101, an operating condition memory 102, a processing state data acquirer 103, a processing state data memory 104, a learning model generator 105, and a learning model memory 106. As illustrated in FIG. 3, the components of the deterioration determining apparatus 100 that function in the estimating phase include the operating condition acquirer 101, the operating condition memory 102, an actual data acquirer 111, a predicted data acquirer 112, a determiner 113, and an output unit 114.

The operating condition acquirer 101 acquires an operating condition of each processing device 1 that executes the predetermined process. Specifically, the operating condition acquirer 101 acquires an operating condition that is a command value input to the controller 5 of each processing device 1. In the present embodiment, the operating condition of each processing device 1 is stored in the server 10 (see FIG. 1). The operating condition acquirer 101 thus acquires the operating condition from the server 10. Alternatively, the operating condition acquirer 101 may directly acquire the operating condition from each processing device 1.

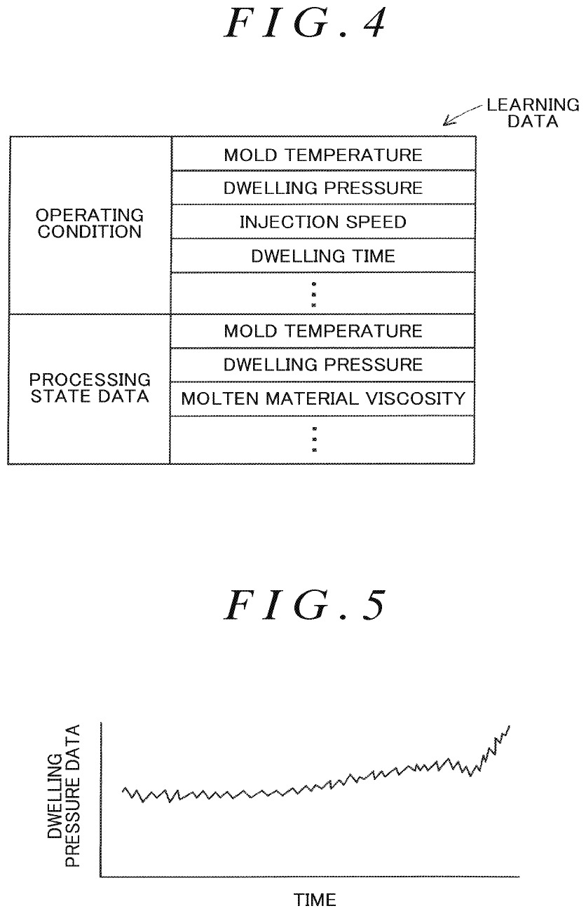

The operating condition acquired by the operating condition acquirer 101 is stored in the operating condition memory 102. The operating condition memory 102 stores operating conditions concerning a large number of molded articles, such that the operating conditions are each linked with an associated one of the molded articles. As illustrated in FIG. 4, examples of the operating conditions include a mold temperature, a dwelling pressure, an injection speed, a dwelling time, a mold clamping force, and the amount of molten material retained in the heating cylinder 32.

The processing state data acquirer 103 acquires processing state data detected by the injection unit sensor 37 and the mold clamp sensor 45 (that are attached to each processing device 1) during execution of the predetermined process by each processing device 1. In the present embodiment, the processing state data concerning each processing device 1 is stored in the server 10 (see FIG. 1). The processing state data acquirer 103 thus acquires the processing state data from the server 10. Alternatively, the processing state data acquirer 103 may directly acquire the processing state data from each processing device 1.

The processing state data acquired by the processing state data acquirer 103 is stored in the processing state data memory 104. The processing state data memory 104 stores processing state data concerning a large number of molded articles, such that each piece of the processing state data is linked with an associated one of the molded articles. As illustrated in FIG. 4, examples of the processing state data include a mold temperature, a dwelling pressure, a molten material viscosity, an injection speed, a dwelling time, a mold clamping force, and the amount of molten material retained in the heating cylinder 32.

The processing state data may be time-varying behaviors of target data type or may be predetermined statistics obtained from information on the behaviors. As illustrated in FIG. 5, the processing state data may be, for example, time-varying behaviors of dwelling pressure data during molding of a single molded article or statistics obtained from the behaviors. The number of behaviors corresponds to the number of sampling times for the target data type. The statistics may be selected from among various statistics, such as an integral value for an entire period (e.g., a period between the start and end of molding), an integral value for a predetermined partial period, a differential value at a predetermined time, a maximum value, and a maximum differential value.

The first exemplary deterioration determining apparatus 100 is described on the assumption that the operating condition memory 102 and the processing state data memory 104 are separate memories (or separate databases). Alternatively, the operating condition memory 102 and the processing state data memory 104 may be integral with each other so as to provide a single integrated memory (or a single integrated database). In such a case, the operating conditions and the processing state data are stored in the integrated memory such that each operating condition and each piece of the processing state data are linked with an associated one of molded articles.

As illustrated in FIG. 4, the learning model generator 105 conducts machine learning using, as learning data, the operating conditions stored in the operating condition memory 102 and the processing state data stored in the processing state data memory 104. The learning model generator 105 conducts the machine learning so as to preliminarily generate a learning model concerning the operating conditions and the processing state data. Although the present embodiment is described on the assumption that machine learning is supervised learning, any other suitable machine learning algorithm may be used. The learning model generated by the learning model generator 105 is stored in the learning model memory 106.

The deterioration determining apparatus 100 determines the degree of deterioration in each processing device 1. The deterioration determining apparatus 100 uses the learning model in order to acquire data on each processing device 1 in a non-deteriorated state (i.e., data on each processing device 1 in an initial state). For this purpose, the learning model generator 105 preliminarily generates the learning model for the initial state by conducting machine learning using, as learning data, the operating condition and the processing state data of each processing device 1 in the initial state.

The operating condition memory 102 and the processing state data memory 104 store information acquired for each processing device 1 in the initial state (i.e., the operating condition and processing state data of each processing device 1 in the initial state). An initial state period may be responsive to a period during which each processing device 1 deteriorates. For example, suppose that a period between the start of use of each processing device 1 and a time at which each processing device 1 enters a normal deteriorated state is about five years. In this case, the initial state period lasts about a month to about six months from the start of use of each processing device 1. The initial state period may be freely determined in accordance with, for example, the average life of the processing devices 1, the type of each processing device 1, components of each processing device 1, the life of each component, the frequency of use of each processing device 1, and an environment where each processing device 1 is used.

The server 10 of the deterioration determining system 50 is able to acquire information on the processing devices 1 (e.g., the operating conditions and processing state data of the processing devices 1). The learning model generator 105 is thus able to conduct machine learning using a large number of pieces of learning data for the processing devices 1 in the initial state. Usually, the larger the number of pieces of learning data, the higher the accuracy of machine learning will be. Accordingly, the configuration of the deterioration determining system 50 described above enhances the accuracy of the learning model.

The learning model generator 105 conducts machine learning using a large number of pieces of learning data for the processing devices 1 in the initial state. Thus, the learning model generated by the learning model generator 105 is not a learning model specific to the particular processing device 1 but a learning model provided in consideration of the processing devices 1. Consequently, the learning model generated by the learning model generator 105 is available for wide use.

The actual data acquirer 111 acquires actual data. The actual data is processing state data acquired by the processing state data acquirer 103 at a determining time. As used herein, the term “determining time” refers to a time at which deterioration in each processing device 1 is determined. In the present embodiment, each processing device 1 undergoes constant monitoring, so that information on the processing devices 1 is constantly stored in the server 10. Thus, the determining time is any time during constant monitoring of each processing device 1. Alternatively, each processing device 1 may undergo regular monitoring. In such a case, the determining time may be a time at which each processing device 1 undergoes regular monitoring.

The predicted data acquirer 112 acquires operating conditions at the determining time from the operating condition acquirer 101. The predicted data acquirer 112 acquires predicted data using the learning model stored in the learning model memory 106. The predicted data is processing state data for the operating conditions at the determining time. As previously mentioned, the learning model is a model for the operating conditions and the processing state data. Thus, information on the processing state data is output using the learning model by inputting the operating conditions. The information output using the learning model is the predicted data. The predicted data is similar in type to the learning data used for the generation of the learning model by the learning model generator 105. In other words, the predicted data may be time-varying behaviors of the target data type or predetermined statistics obtained from information on the behaviors.

The determiner 113 acquires the actual data acquired by the actual data acquirer 111 and the predicted data acquired by the predicted data acquirer 112. The determiner 113 calculates an indicator indicative of the degree of divergence between the actual data and the predicted data. The indicator will hereinafter be referred to as a “divergence value”. As used herein, the term “divergence value” refers to an indicator indicative of a gap between the actual data and the predicted data.

Suppose that a gap is found between the actual data and the predicted data at each predetermined time when the actual data and the predicted data are time-varying behavior information for the target data type. Data indicative of the behaviors is data obtained during a period between the start and end of molding for a single molded article. In this case, examples of the divergence value include a maximum value of the gap and an integral value of the gap (e.g., an integral value of the gap for a period between the start and end of molding).

When the actual data and the predicted data are predetermined statistics obtained from information on the behaviors, the divergence value is a difference between the statistic of the actual data and the statistic of the predicted data. The statistics may be selected from among various statistics, such as an integral value for an entire period (e.g., a period between the start and end of molding), an integral value for a predetermined partial period, a differential value at a predetermined time, a maximum value, and a maximum differential value. For example, suppose that the statistics are integral values for a predetermined partial period. In this case, the actual data and the predicted data are the integral values, so that a difference between the actual data and the predicted data is calculable. The value of the difference calculated is the divergence value.

The determiner 113 determines the degree of deterioration in each processing device 1 in accordance with the divergence value calculated. For example, suppose that the divergence value is greater than a predetermined value. In this case, the determiner 113 determines that the degree of deterioration in the processing device 1 is significant. Specifically, the determiner 113 determines that the processing device 1 needs checkup or maintenance.

The processing state data, the actual data, and the predicted data used in the present embodiment may be of the types described above. Thus, the divergence value may be of a plurality of types. When any one of the types of divergence values is greater than a predetermined value, the determiner 113 may determine that the degree of deterioration is significant. When predetermined ones of the types of divergence values are each greater than a predetermined value, the determiner 113 may determine that the degree of deterioration is significant. When the sum of divergence values of the types to which weights are assigned is greater than a predetermined value, the determiner 113 may determine that the degree of deterioration is significant.

When the degree of deterioration determined by the determiner 113 is greater than a predetermined value, the output unit 114 outputs guidance on checkup or maintenance. The output unit 114 gives, for example, guidance by presentation on a display (not illustrated), guidance by sound, and guidance by an indicator light. The output unit 114 may present guidance, for example, on a display of the deterioration determining apparatus 100, may present guidance, for example, on a display of the target processing device 1, or may present guidance, for example, on a display of any other suitable management device, such as the server 10. The output unit 114 may present guidance on a portable terminal owned by an operator or a manager.

The learning model is preliminarily generated by the learning model generator 105 of the deterioration determining apparatus 100. The learning model indicates relationships between the operating conditions and the processing state data used for the generation of the learning model. The actual data acquirer 111 acquires the actual data that is the processing state data at the determining time different from a time at which the learning model is generated.

The predicted data acquirer 112 acquires the operating conditions at the determining time. Using the operating conditions acquired and the learning model preliminarily generated, the predicted data acquirer 112 acquires the predicted data that is the processing state data. Because the predicted data is acquired using the preliminarily generated learning model, the predicted data is equivalent to data indicative of a state of each processing device 1 that has operated for the generation of the learning model (i.e., data indicative of a state of each processing device 1 where the degree of deterioration is lower than the degree of deterioration at the determining time).

The determiner 113 determines the degree of deterioration in each processing device 1 in accordance with the divergence value between the actual data and the predicted data. When the actual data is significantly divergent from the predicted data, the determiner 113 determines that the degree of deterioration in the processing device 1 is significant. When the actual data is slightly divergent from the predicted data, the determiner 113 determines that the degree of deterioration in the processing device 1 is slight.

The present embodiment involves, in particular, using the processing state data, the actual data, and the predicted data as predetermined statistics. The determiner 113 acquires the divergence value that is the difference between the actual data and the predicted data. In accordance with the divergence value, the determiner 113 determines the degree of deterioration in each processing device 1. Consequently, the present embodiment considerably facilitates the determining process performed by the determiner 113.

The learning model generator 105 conducts machine learning using, as the learning data, the operating condition and processing state data of each processing device 1 in the initial state. The learning model generator 105 thus preliminarily generates the learning model for the initial state. Accordingly, the determiner 113 determines the degree of deterioration in each processing device 1 at the determining time with reference to the degree of deterioration in the initial state. In other words, the determiner 113 is able to reliably determine deterioration in each processing device 1 over time.

The actual data may include data on an unexpected abnormality (which may hereinafter be referred to as “unexpected abnormality data”). The determiner 113 should not determine that the degree of deterioration in the processing device 1 is significant because of such unexpected abnormality data. To avoid making an erroneous determination caused by unexpected abnormality data, the determiner 113 may perform determining processes described below.

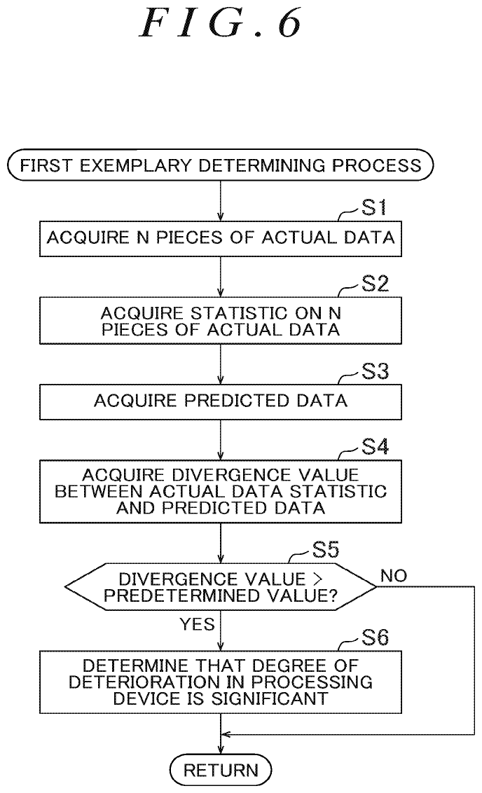

Referring to FIG. 6, a first exemplary determining process to be performed by the determiner 113 will be described. In step S1, the determiner 113 acquires N pieces of actual data for the predetermined process executed N times (where N is two or more). In step S2, the determiner 113 acquires a statistic on the N pieces of actual data. As used herein, the term “statistic on the N pieces of actual data” refers to the average value of the N pieces of actual data or an indicator (e.g., a three sigma value) that uses a standard deviation of the N pieces of actual data.

For example, suppose that 100 pieces of actual data include a single piece of unexpected abnormality data. In this case, the average value of the 100 pieces of actual data is a value by which the influence of the unexpected abnormality data is relatively smaller than when the determiner 113 acquires the statistic on the actual data for only the predetermined process during which an unexpected abnormality has occurred. The same applies to the case where the determiner 113 acquires a three sigma value.

In step S3, the determiner 113 acquires predicted data. In step S4, the determiner 113 acquires a divergence value between the predicted data and the statistic on the N pieces of actual data. When the divergence value is greater than a predetermined value (S5: Yes), the determiner 113 determines in step S6 that the degree of deterioration in the processing device 1 is significant. When the divergence value is equal to or smaller than the predetermined value (S5: No), the determiner 113 skips step S6 and returns the determining process to step S1 so as to repeat step S1 and the subsequent steps.

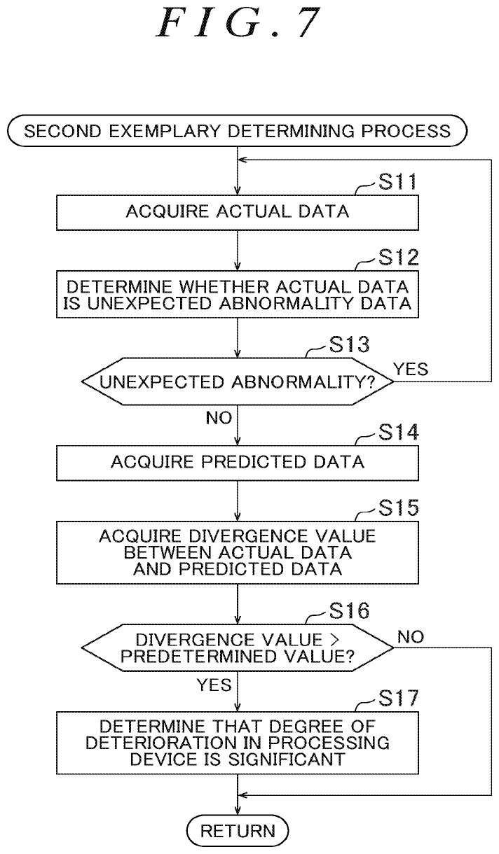

Referring to FIG. 7, the following description discusses a second exemplary determining process that prevents the determiner 113 from making an erroneous determination caused by actual data containing unexpected abnormality (unexpected abnormality data). In step S11, the determiner 113 acquires a single piece of actual data. In step S12, the determiner 113 determines whether the actual data is unexpected abnormality data. The determiner 113 is able to determine whether the actual data is unexpected abnormality data by, for example, making a comparison between the actual data acquired in step S11 and actual data acquired in the past and checking whether a great difference is found therebetween.

When the actual data is unexpected abnormality data (S13: Yes), the determiner 113 returns the determining process to step S11 so as to repeat step S11 and the subsequent steps. In this case, the determiner 113 acquires next actual data in step S11. When the actual data is not unexpected abnormality data (S13: No), the determiner 113 acquires predicted data in step S14.

In step S15, the determiner 113 acquires a divergence value between the actual data and the predicted data. When the divergence value is greater than a predetermined value (S16: Yes), the determiner 113 determines in step S17 that the degree of deterioration in the processing device 1 is significant. When the divergence value is equal to or smaller than the predetermined value (S16: No), the determiner 113 skips step S17 and returns the determining process to step S11 so as to repeat step S11 and the subsequent steps.

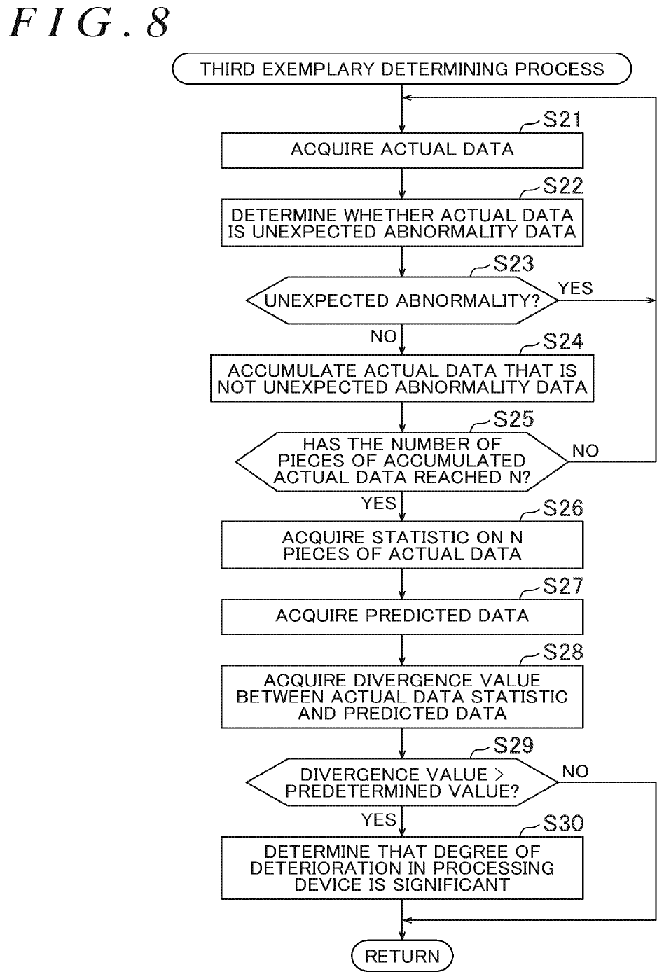

Referring to FIG. 8, the following description discusses a third exemplary determining process that prevents the determiner 113 from making an erroneous determination caused by unexpected abnormality data. In step S21, the determiner 113 acquires a single piece of actual data. In step S22, the determiner 113 determines whether the actual data is unexpected abnormality data. The determiner 113 is able to determine whether the actual data is unexpected abnormality data by, for example, making a comparison between the actual data acquired in step S21 and actual data acquired in the past and checking whether a great difference is found therebetween.

When the actual data is unexpected abnormality data (S23: Yes), the determiner 113 returns the determining process to step S21 so as to repeat step S21 and the subsequent steps. In this case, the determiner 113 acquires next actual data in step S21. When the actual data is not unexpected abnormality data (S23: No), the determiner 113 accumulates, in step S24, the actual data that is not unexpected abnormality data. In step S25, the determiner 113 determines whether the number of pieces of actual data that is not unexpected abnormality data has reached N (where N is two or more). The determiner 113 repeats steps S21 to S25 until the number of pieces of actual data that is not unexpected abnormality data reaches N (S25: No).

When the number of pieces of actual data that is not unexpected abnormality data has reached N (S25: Yes), the determiner 113 acquires a statistic on the N pieces of actual data in step S26. The statistic on the N pieces of actual data is, for example, the average value of the N pieces of actual data. In step S27, the determiner 113 acquires predicted data.

In step S28, the determiner 113 acquires a divergence value between the actual data and the predicted data. When the divergence value is greater than a predetermined value (S29: Yes), the determiner 113 determines in step S30 that the degree of deterioration in the processing device 1 is significant. When the divergence value is equal to or smaller than the predetermined value (S29: No), the determiner 113 skips step S30 and returns the determining process to step S21 so as to repeat step S21 and the subsequent steps.

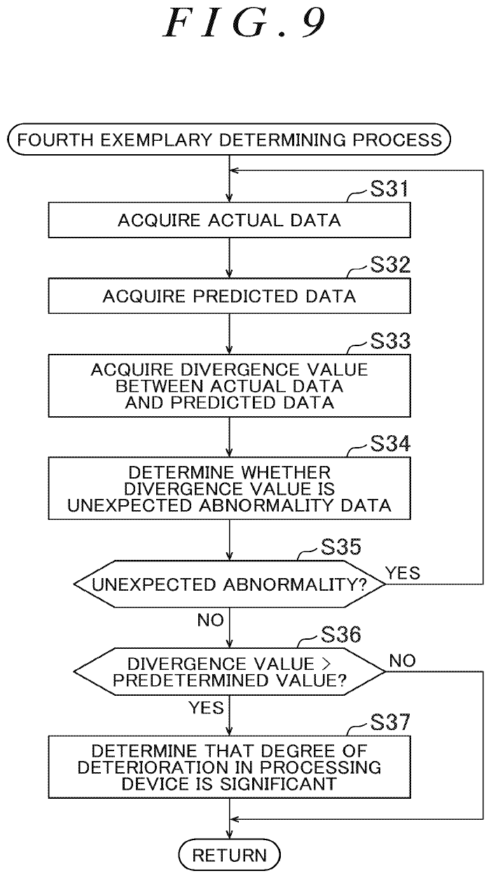

Referring now to FIG. 9, the following description discusses a fourth exemplary determining process that prevents the determiner 113 from making an erroneous determination caused by unexpected abnormality data. In step S31, the determiner 113 acquires a single piece of actual data. In step S32, the determiner 113 acquires predicted data. In step S33, the determiner 113 acquires a divergence value between the actual data and the predicted data.

In step S34, the determiner 113 determines whether the divergence value is unexpected abnormality data. The determiner 113 is able to determine whether the divergence value is unexpected abnormality data by, for example, making a comparison between the divergence value acquired in step S33 and a divergence value acquired in the past and checking whether a significant change is found therebetween. When the divergence value is unexpected abnormality data (S35: Yes), the determiner 113 returns the determining process to step S31 so as to repeat step S31 and the subsequent steps. In this case, the determiner 113 acquires next actual data in step S31, acquires next predicted data in step S32, and then acquires a divergence value between the actual data and the predicted data again in step S33.

When the divergence value is not unexpected abnormality data (S35: No), the determiner 113 determines whether the divergence value is greater than a predetermined value in step S36. When the divergence value is greater than the predetermined value (S36: Yes), the determiner 113 determines in step S37 that the degree of deterioration in the processing device 1 is significant. When the divergence value is equal to or smaller than the predetermined value (S36: No), the determiner 113 skips step S37 and returns the determining process to step S31 so as to repeat step S31 and the subsequent steps.

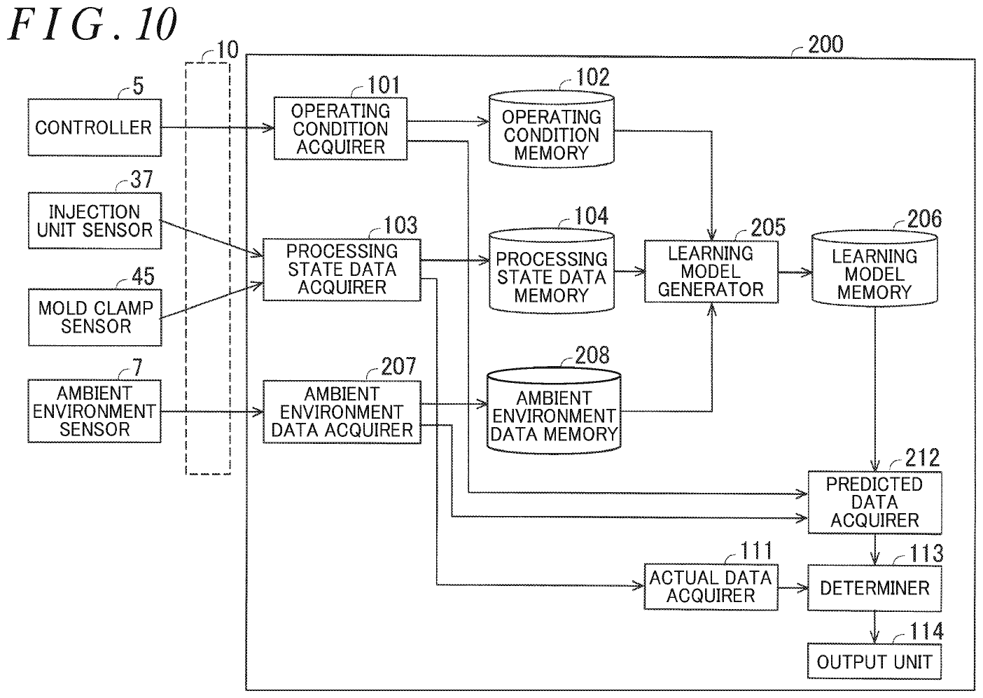

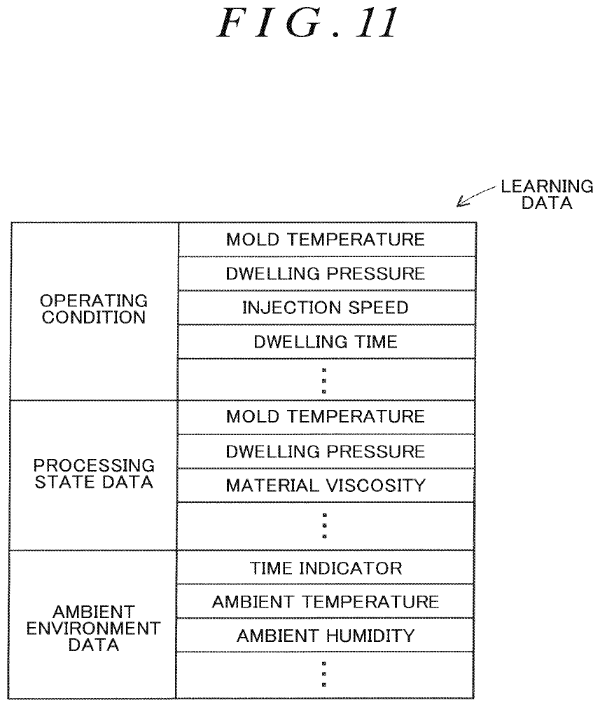

The deterioration determining apparatus 200 according to a second example (which may hereinafter be referred to as a “second exemplary deterioration determining apparatus 200”) will be described with reference to FIGS. 10 and 11. The deterioration determining apparatus 200 includes components that function in a learning phase of machine learning, and components that function in an estimating phase of machine learning.

As illustrated in FIG. 10, the components of the deterioration determining apparatus 200 that function in the learning phase include an operating condition acquirer 101, an operating condition memory 102, a processing state data acquirer 103, a processing state data memory 104, an ambient environment data acquirer 207, an ambient environment data memory 208, a learning model generator 205, and a learning model memory 206. As illustrated in FIG. 10, the components of the deterioration determining apparatus 200 that function in the estimating phase include the operating condition acquirer 101, the operating condition memory 102, an actual data acquirer 111, a predicted data acquirer 212, a determiner 113, and an output unit 114. The components of the second exemplary deterioration determining apparatus 200 similar to the components of the first exemplary deterioration determining apparatus 100 will be identified by the same reference characters, and description thereof will be omitted.

The ambient environment data acquirer 207 acquires, from the ambient environment sensor 7, ambient environment data during execution of the predetermined process by each processing device 1. Examples of the ambient environment data acquired by the ambient environment data acquirer 207 include a time indicator, an ambient temperature, and an ambient humidity. The ambient environment data acquired by the ambient environment data acquirer 207 is stored in the ambient environment data memory 208. The ambient environment data memory 208 stores the ambient environment data on a large number of molded articles such that each piece of the ambient environment data is linked with an associated one of the molded articles.

The deterioration determining apparatus 200 is described on the assumption that the operating condition memory 102, the processing state data memory 104, and the ambient environment data memory 208 are separate memories (or separate databases). Alternatively, the operating condition memory 102, the processing state data memory 104, and the ambient environment data memory 208 may be integral with each other so as to provide a single integrated memory (or a single integrated database). In such a case, the operating conditions, the processing state data, and the ambient environment data are stored in the integrated memory, such that each operating condition, each piece of the processing state data, and each piece of the ambient environment data are linked with an associated one of the molded articles.

As illustrated in FIG. 11, the learning model generator 205 conducts machine learning using, as learning data, the operating conditions stored in the operating condition memory 102, the processing state data stored in the processing state data memory 104, and the ambient environment data stored in the ambient environment data memory 208. The learning model generator 205 conducts the machine learning so as to preliminarily generate a learning model concerning the operating conditions, the processing state data, and the ambient environment data. The learning model generated by the learning model generator 205 is stored in the learning model memory 206.

The deterioration determining apparatus 200 determines the degree of deterioration in each processing device 1. The deterioration determining apparatus 200 uses the learning model in order to acquire data on each processing device 1 in a non-deteriorated state (i.e., data on each processing device 1 in an initial state). For this purpose, the learning model generator 205 preliminarily generates the learning model for the initial state by conducting machine learning using, as learning data, the operating condition, the processing state data, and the ambient environment data of each processing device 1 in the initial state. The learning model generator 205 is substantially similar to the learning model generator 105 of the first exemplary deterioration determining apparatus 100 except that the learning model generator 205 uses, as learning data, the ambient environment data in addition to the operating conditions and the processing state data.

The predicted data acquirer 212 acquires operating conditions at the determining time from the operating condition acquirer 101. The predicted data acquirer 212 acquires ambient environment data at the determining time from the ambient environment data acquirer 207. The predicted data acquirer 212 acquires predicted data using the learning model stored in the learning model memory 206. The predicted data is processing state data for the operating conditions and ambient environment data at the determining time.

As previously described, the learning model is a model for the operating conditions, the processing state data, and the ambient environment data. Thus, information on the processing state data is output using the learning model by inputting the operating conditions and ambient environment data. The information output from the learning model is the predicted data. The predicted data is similar in type to the learning data used for the generation of the learning model by the learning model generator 205. In other words, the predicted data may be time-varying behaviors of the target data type or predetermined statistics obtained from information on the behaviors.

The learning model is preliminarily generated by the learning model generator 205 of the deterioration determining apparatus 200. The learning model indicates relationships between the operating conditions, the processing state data, and the ambient environment data used for the generation of the learning model. The actual data acquirer 111 acquires the actual data that is the processing state data at the determining time different from a time at which the learning model is generated.

The predicted data acquirer 212 acquires the operating conditions and ambient environment data at the determining time. Using the operating conditions and ambient environment data acquired and the learning model preliminarily generated, the predicted data acquirer 212 acquires the predicted data that is the processing state data. Because the predicted data is acquired using the preliminarily generated learning model, the predicted data is equivalent to data indicative of a state of the processing device 1 that has operated for the generation of the learning model (i.e., data indicative of a state of the processing device 1 where the degree of deterioration is lower than the degree of deterioration at the determining time). The predicted data is acquired in consideration of an ambient environment.

The determiner 113 determines the degree of deterioration in each processing device 1 in accordance with the divergence value between the actual data and the predicted data. When the actual data is significantly divergent from the predicted data, the determiner 113 determines that the degree of deterioration in the processing device 1 is significant. When the actual data is slightly divergent from the predicted data, the determiner 113 determines that the degree of deterioration in the processing device 1 is slight. Because the ambient environment is taken into consideration, the deterioration determining apparatus 200 is able to determine the degree of deterioration in each processing device 1 with higher accuracy.

The first exemplary deterioration determining apparatus 100 has been described on the assumption that the learning model is a model concerning the operating conditions and the processing state data. The second exemplary deterioration determining apparatus 200 has been described on the assumption that the learning model is a model concerning the operating conditions, the processing state data, and the ambient environment data. The learning model generator 105 of the first exemplary deterioration determining apparatus 100 may alternatively conduct machine learning using learning data that further includes additional information other than the operating conditions and the processing state data. In such a case, the learning model is a model that indicates relationships between the operating conditions, the processing state data, and the additional information. The learning model generator 205 of the second exemplary deterioration determining apparatus 200 may alternatively conduct machine learning using learning data that further includes additional information other than the operating conditions, the processing state data, and the ambient environment data. In such a case, the learning model is a model that indicates relationships between the operating conditions, the processing state data, the ambient environment data, and the additional information.

What is claimed is:

1. A deterioration determining apparatus comprising:
an operating condition acquirer to acquire an operating condition of a processing device that executes a predetermined process;
a processing state data acquirer to acquire processing state data detected by a sensor during the execution of the predetermined process by the processing device, the sensor being attached to the processing device;
a learning model generator to conduct machine learning using, as learning data, the operating condition and the processing state data so as to preliminarily generate a learning model concerning the operating condition and the processing state data;
an actual data acquirer to acquire actual data, the actual data being the processing state data at a determining time;
a predicted data acquirer to acquire predicted data using the learning model, the predicted data being the processing state data for the operating condition at the determining time; and
a determiner to determine a degree of deterioration in the processing device in accordance with a degree of divergence between the actual data and the predicted data.

2. The deterioration determining apparatus according to claim 1, wherein:
the processing state data, the actual data, and the predicted data are predetermined statistics;
the determiner acquires an indicator indicative of the degree of divergence, the indicator being a difference between the actual data and the predicted data; and
the determiner determines the degree of deterioration in the processing device in accordance with the indicator indicative of the degree of divergence.

3. The deterioration determining apparatus according to claim 1, wherein the learning model generator conducts machine learning using, as the learning data, the operating condition and the processing state data of the processing device in an initial state so as to preliminarily generate the learning model for the initial state.

4. The deterioration determining apparatus according to claim 1, further comprising an ambient environment data acquirer to acquire ambient environment data during the execution of the predetermined process by the processing device, wherein:
the learning model generator conducts machine learning using, as the learning data, the operating condition, the processing state data, and the ambient environment data so as to preliminarily generate the learning model concerning the operating condition, the processing state data, and the ambient environment data; and
the predicted data acquirer acquires the predicted data using the learning model, the predicted data being the processing state data for the operating condition and the ambient environment data at the determining time.

5. The deterioration determining apparatus according to claim 4, wherein:
the processing device supplies a molten material into a mold so as to form a molded article; and
the processing state data includes at least one of a dwelling pressure, a mold temperature, and a viscosity of the molten material.

6. The deterioration determining apparatus according to claim 4, wherein:
the processing device supplies a molten material into a mold so as to form a molded article;
the processing state data includes at least one of a dwelling pressure, a mold temperature, and a viscosity of the molten material; and
the ambient environment data includes at least one of a time indicator, an ambient temperature, and an ambient humidity.

7. The deterioration determining apparatus according to claim 1, wherein:
the determiner acquires an indicator indicative of the degree of divergence, the indicator being a difference between the predicted data and a statistic on a plurality of pieces of the actual data for a plurality of the predetermined processes;
the determiner determines the degree of deterioration in the processing device in accordance with the indicator indicative of the degree of divergence; and
when an unexpected abnormality has occurred during any one of the predetermined processes, the statistic on the pieces of actual data is a value by which influence of data on the unexpected abnormality is relatively smaller than when the determiner uses a statistic on the actual data for only the predetermined process during which the unexpected abnormality has occurred.

8. The deterioration determining apparatus according to claim 1, wherein the determiner determines the degree of deterioration in the processing device in accordance with an indicator indicative of the degree of divergence between the predicted data and the actual data that includes no data on an unexpected abnormality.

9. The deterioration determining apparatus according to claim 1, further comprising an output unit to output guidance on checkup or maintenance when the degree of deterioration is greater than a predetermined value.

10. A deterioration determining system comprising:
a plurality of processing devices to execute a predetermined process;
a server that is able to communicate with the processing devices, the server being configured to collect operating conditions of the processing devices and processing state data detected by a sensor during the execution of the predetermined process by each of the processing devices, the sensor being attached to each of the processing devices; and
the deterioration determining apparatus according to claim 1, wherein the deterioration determining apparatus determines a degree of deterioration in each of the processing devices in accordance with the operating conditions and the processing state data collected by the server.
